(19) United States
(12) Patent Application Publication
(10) Pub. No.: US 2025/0038285 A1
(43) Pub. Date: Jan. 30, 2025

(54) BATTERY ARRANGEMENT AND METHOD FOR DETECTING A GAS DISCHARGE FROM A BATTERY CELL

(71) Applicant: AUDI AG, Ingolstadt (DE)

(72) Inventor: Markus PFEIFF, Kösching (DE)

(73) Assignee: AUDI AG, Ingolstadt (DE)

(21) Appl. No.: 18/731,758

(22) Filed: Jun. 3, 2024

(30) Foreign Application Priority Data
Jul. 25, 2023 (DE) 102023119694.4

(51) Int. Cl. H01M 10/48; H01M 10/613; H01M 10/6554; H01M 50/204; H01M 50/342

(52) U.S. Cl. CPC H01M 10/482; H01M 10/613; H01M 10/6554; H01M 50/204; H01M 50/3425; H01M 2200/20; H01M 2220/20

(57) ABSTRACT

A battery arrangement with a sensor device for detecting a gas discharge from at least one battery cell of the battery arrangement. The battery cell has a releasable cell degassing opening. The sensor device for detecting the gas discharge has a sensor unit with an electrical line which can be subjected to a test voltage. The sensor unit is arranged in such a way that a gas escaping from the cell degassing opening impinges on the sensor unit, and the electrical line can be damaged by a gas flowing out of the cell degassing opening. In particular, the sensor unit is designed in such a way that the electrical line can be damaged by the outflow pressure of a gas discharging from the cell degassing opening in the event of thermal runaway of the battery cell.

### FIELD

The invention relates to a battery arrangement with a sensor device for detecting a gas discharge from at least one battery cell of the battery arrangement, wherein the battery arrangement comprises at least one battery cell which has a releasable cell degassing opening, and wherein the sensor device for detecting the gas discharge comprises a sensor unit with an electrical line to which a test voltage can be applied, wherein the sensor unit is arranged such that a gas discharging from the cell degassing opening impinges on the sensor unit, and wherein the electrical line can be damaged by a gas flowing out of the cell degassing opening. Furthermore, the invention also relates to a method for detecting a gas discharge.

### BACKGROUND

Individual battery cells of batteries, e.g. high-voltage battery systems, can generate internal pressure for many different reasons. This happens, for example, in the event of thermal runaway of such a battery cell. The battery cells often have a weakening in the housing, which is generally referred to as a releasable cell degassing opening, to prevent the battery cell from bursting. This releasable cell degassing opening enables controlled outgassing of the battery cell in the event of excess pressure. Cell outgassing is an indication of a possible critical failure in the battery and subsequent damage, including thermal propagation of the system. For this reason, it is advantageous to identify such a fault case, for example to initiate user warnings and safety functions within the high-voltage battery.

DE 10 2012 212 378 A1 describes a degassing device for discharging fluid from at least one battery cell, wherein the degassing device can be fluidically coupled to the battery cell and has a signal generating device with which the discharge of fluids can be detected and a corresponding signal can be generated. The signal generating device can comprise a bursting member which is designed as a valve and which is arranged in an outlet opening of the degassing device. An electrical conduction element can be embedded in the bursting element. The degassing device can therefore itself form the releasable cell degassing opening of a battery cell.

The integration of a signaling device into the releasable cell degassing openings of battery cells themselves requires a relatively complex design of each individual battery cell.

DE 10 2014 006 807 A1 describes a battery system with at least one individual battery cell arranged on a housing, wherein the individual battery cell has a cell valve device that opens at a predeterminable internal cell pressure. The battery system further comprises a sensor device for detecting an opening of the cell valve device and/or detecting a temperature inside the housing. For this purpose, the sensor device may comprise a control wire which may extend over the cell valve device. This wire can be designed as a thermal resistor, so that when the temperature changes, its electrical resistance and thus the voltage drop caused by it changes. The wire can also be designed as optical fibers, which change their optical properties when the temperature changes. The control wire can also include temperature measuring points.

If the temperature of a battery cell or of the discharging gas is to be used to detect the gas discharge, the corresponding elements should be positioned as directly as possible at the gas discharge point. However, this could hinder the discharge of gas from the cell. In addition, some cell manufacturers do not allow the placement of third-party components in the region of the accessible cell degassing openings or on the cells themselves. In case the gas discharging from a cell is not hot enough, as is the case in the case of so-called cold degassing, such a gas discharge is either not detectable with the measures described above or can only be detected in a very complex manner.

### SUMMARY

The object of the present invention is to provide a battery arrangement and a method for detecting a gas discharge, which allow a gas discharge from a cell to be detected in the most efficient manner possible and at the same time as reliably as possible in as many different situations as possible.

The battery arrangement according to the invention comprises a sensor device for detecting a gas discharge from at least one battery cell of the battery arrangement, which in turn comprises a releasable cell degassing opening. The sensor device for detecting the gas discharge comprises a sensor unit with an electrical line to which a test voltage can be applied, wherein the sensor unit is arranged such that a gas discharging from the cell degassing opening impinges on the sensor unit and wherein the electrical line can be damaged by a gas discharging from the cell degassing opening. The sensor unit is designed in such a way that the electrical line can be damaged by the flow pressure of a gas discharging from the cell degassing opening in the event of thermal runaway of the battery cell.

The invention is based on the knowledge that not only the temperature of the discharging gas can be used to detect gas discharge, but also the outflow pressure. This makes it possible, for example, to detect discharging gases regardless of temperature. Furthermore, the invention is based on the finding that in order to utilize the discharge pressure for the detection of gas discharge, it is not necessary to design the sensor unit itself as the releasable cell degassing opening or to integrate it into it. The electrical line used to detect the gas discharge can thus advantageously be formed separately from the releasable cell degassing opening of the at least one battery cell, so that conventional battery cells can be used to detect the gas discharge. In other words, the gas discharge can be detected not only in certain battery cells, but in principle in any battery cell with a releasable cell degassing opening. The provision of a sensor unit separate from the battery cell for detecting gas discharges thus enables a particularly cost-effective and efficient detection method. By using the outflow pressure of the gas flowing out of the cell degassing opening, it is also possible to arrange the electrical line of the sensor unit, which can be damaged by the outflow pressure, at a significantly greater distance from the cell degassing opening. In addition, the sensor unit does not have to be fixed to the battery cell for this purpose. This is an efficient way to prevent gas discharging from the cell from being obstructed and also to easily comply with manufacturer specifications.

The at least one battery cell can be formed, for example, as lithium-ion cells. The releasable cell degassing opening of the battery cell can be designed as a predetermined breaking point in the cell housing of the battery cell. For example, the cell degassing opening may be provided as a bursting membrane or a pressure relief valve or the like. The releasable cell degassing opening represents a passively opening element, e.g. one that opens depending on pressure, and therefore does not require active control to release the opening.

The battery arrangement may comprise not only one such battery cell, but preferably several, as explained in more detail later. The sensor device may comprise only one or a few electrical lines to detect gas discharge from one of these several battery cells. In particular, the number of electrical lines required for this purpose can be significantly lower than the number of battery cells in the battery arrangement if the battery arrangement has several battery cells and not just a single battery cell. This makes the sensor device particularly efficient.

The electrical line may comprise an electrical conductor or be designed as such. The electrical line can consist entirely of electrically conductive material, preferably metal. The electrical line itself preferably does not have a sheath like a cable. The electrical line can, for example, be designed as a single, conductive wire, in particular as a stranded wire. The electrical line can also represent a conductor track or conductor track arrangement, which is arranged, for example, on a conductor track substrate or embedded in a conductor track substrate, which can represent the carrier described in more detail later. Such a sheath can optionally be part of the sensor unit, as explained in more detail later, but not part of the electrical line itself. The electrical line should therefore be made entirely of electrically conductive material.

In order to arrange the sensor unit such that a gas emerging from the cell degassing opening impinges on the sensor unit, the sensor unit can be arranged opposite at least a part of the cell degassing opening with respect to a certain direction, which is also referred to below as the first direction. The sensor unit does not necessarily have to be arranged in contact with the cell degassing opening, but can also be arranged at a distance from the cell degassing opening.

Because the electrical line can be subjected to a test voltage, damage to the electrical line can be easily detected by the discharge pressure of the gas flowing out of the cell degassing opening. For this purpose, for example, a measuring device can be provided as part of the sensor device, which detects and evaluates at least one electrical variable relating to the electrical line in order to detect damage to the electrical line, in particular a severing of the electrical line. The measuring device can also be designed to apply the test voltage to the electrical line. In addition, the measuring device is designed to carry out the measurement of the electrical variable while the electrical line is subjected to the test voltage.

Therefore, it represents a further, very advantageous embodiment of the invention if the sensor unit is designed to detect damage to the line subjected to the test voltage as a function of a measured electrical variable associated with the lines and to detect the gas discharge as a function of the detected damage to the line. Such a measured electrical variable can be, for example, a current or an electrical resistance, e.g. the line resistance of the electrical line, or several of these electrical variables can be recorded and evaluated. If, for example, a voltage is applied to the electrical line, this results in a current flow through the electrical line. An interruption in the electrical line then results in an interruption in the flow of current. Especially if the electrical line is to be used or is used to detect a gas discharge from any one of several battery cells in the battery arrangement, the electrical line can be designed to be more complex. For example, this can then be designed as a line arrangement or conductor track arrangement, which, for example, has several line sections that can be connected in parallel and/or in series. Especially in the case of a parallel connection, a line break in one section of such a parallel branch does not necessarily lead to a complete interruption of the current flow, since current can also be conducted via the other branches. However, the damage of such a parallel branch can be easily detected by the change in the total resistance of this line arrangement or conductor track arrangement. In this case, it is, for example, very advantageous to detect at least the resistance of the electrical line, e.g. its total resistance, as the above-mentioned electrical variable, wherein, if the electrical line comprises several line branches or line sections, the total resistance refers to the overall line arrangement formed by these several sections or branches.

In a further very advantageous embodiment of the invention, the electrical line is arranged at a distance from the releasable cell degassing opening and/or the sensor unit has a carrier made of an electrically non-conductive material, in particular a plastic, on which the electrical line is arranged and/or in which the electrical line is embedded.

On the one hand, it is very advantageous if the electrical line is arranged at a distance from the releasable cell degassing opening. The fact that the electrical line is arranged at a distance from the releasable cell degassing opening can therefore refer to the complete sensor unit, i.e. for example including the carrier, or only to the electrical line itself. In addition, the electrical line can be spaced only from the cell degassing opening or from the entire battery cell including the cell degassing opening.

The distance between the electrical line and the cell degassing opening can also be determined solely by the thickness of the carrier's insulation material. However, the distance can also be greater than the thickness of this insulation material, if present. On the one hand, the distance provides electrical insulation. This can be provided additionally or alternatively by the electrically insulating carrier. Providing the distance has the great advantage that no components have to be arranged or mounted directly on the releasable cell degassing openings of the cells. Blockage of the gas discharge can thus be prevented much more effectively and manufacturer specifications can also be met more easily. By providing a carrier, significantly more flexibility is also provided with regard to the arrangement options, as well as with regard to the design options for the sensor unit, in particular the geometric design options for providing certain mechanical structures, e.g. the possible damage of the electrical line. If the electrical line is embedded in such a carrier, the carrier can also provide electrical insulation to the outside. This also makes it possible, for example, to arrange the sensor unit at least partially on the cells or the at least one battery cell. In addition, by providing a carrier, a certain structural rigidity of the sensor unit can optionally be provided, which accordingly does not have to be provided by the rigidity of the electrical line itself. This also makes it possible, for example, to design the electrical line as a very thin wire, i.e. as a stranded wire, or conductor track, without the sensor unit as a whole becoming unstable. A thin wire or a thin conductor track can be damaged much more easily, which in turn makes the gas discharge much more reliable to detect. The carrier can, for example, provide a frame and/or be designed as a carrier plate and/or carrier film. Furthermore, as explained in more detail later, the carrier can also provide a certain flow resistance with respect to the gas flowing out of the cell degassing opening with the outflow pressure, in particular without having to achieve this by a special design of the electrical line itself. For example, the carrier can provide a very large resistance surface with respect to the flow resistance, while the electrical conductor or the electrical line itself is designed to be very thin. In addition, the fastening of the electrical line is simplified by the provision of a carrier, which optionally does not have to be as thin and delicate as is preferred for the electrical line.

In a further advantageous embodiment of the invention, there is a free space, in particular a gap, between the cell degassing opening and the sensor unit in a first direction. This gap has the advantage of preventing the gas outlet from being blocked and also eliminating the need to place any components directly at the cell degassing opening. Preferably, there is no contact between the sensor unit and the cell degassing opening of the at least one battery cell.

In a further advantageous embodiment of the invention, the sensor unit has a predetermined breaking point, wherein the line can be damaged by damage or breakage of the sensor unit at the predetermined breaking point, in particular wherein the predetermined breaking point is formed in the carrier. The predetermined breaking point can therefore only be formed in the carrier and not in the line, or both in the carrier and in the line. The predetermined breaking point can also be formed only in the line, especially if there is no carrier at all. The provision of a predetermined breaking point makes it easier to damage the electrical line in the event of a gas discharge. This allows a much more reliable and sensitive detection of such a gas discharge. The predetermined breaking point can generally be provided in the carrier and/or in the electrical line. The provision in the carrier has the great advantage that no complex processing of the electrical line itself is required and that it can simply be provided as a thin strand or as a thin wire, which is easily damaged, in particular severed, due to its small diameter. The formation of the predetermined breaking point on the carrier also has the great advantage that the carrier can provide a correspondingly large resistance surface with respect to flow resistance at least in an region opposite the cell degassing opening and at the same time a simple interruption of the sensor unit is made possible by the predetermined breaking point in the carrier. A more robust or wider design of the carrier in certain regions does not lead to an increase in the trigger threshold of the sensor unit as a whole. The predetermined breaking point can therefore only be formed in the carrier and not in the line, or both in the carrier and in the line. The predetermined breaking point can also be formed only in the line, especially if there is no carrier at all.

In a further advantageous embodiment of the invention, the sensor unit has a detection section which is directly opposite the cell degassing opening of the battery cell with respect to a gas outlet direction, wherein the carrier has, at least in the direction section, a carrier surface which is wider with respect to a second direction than a conductor surface of the electrical line. The carrier can therefore be widened in the direction section or at least wider than the electrical line. This has the great advantage that this wide support surface can provide a large flow resistance with respect to the gas flowing out of a cell. As a result, the pressure effect of the gas discharge pressure on the sensor unit is particularly high and triggering it can be ensured particularly easily.

The sensor unit as a whole can, for example, also comprise only the electrical line and/or the carrier. For example, the sensor unit can be provided as an electrical line sheathed by the insulating material of the carrier or as an electrically insulating conductor arrangement or conductor track arrangement. The detection sections define certain regions of this sheathed conductor arrangement or conductor track arrangement. In particular, the detection section defines that region of the sensor unit which is arranged directly opposite the releasable cell degassing opening of the at least one battery cell.

In a further advantageous embodiment of the invention, the battery arrangement has multiple battery cells with respective releasable cell degassing openings. The multiple battery cells can be designed in the same way as described for at least one battery cell. Furthermore, the sensor unit can comprise multiple detection sections, wherein a respective detection section is assigned to exactly one cell degassing opening, wherein the sensor unit has multiple predetermined breaking points, and wherein each detection section is assigned at least one of the predetermined breaking points, which is arranged in particular in an edge region of the detection section and/or adjacent to the detection section. It is preferred that only one predetermined breaking point is assigned to each detection section. As a result, when the gas hits the detection section and this breaks at the assigned predetermined breaking point a lever effect can be used to bend the detection section in the direction of flow without completely detaching it from the rest of the sensor unit by another break at another point.

Because the sensor unit comprises several detection sections that are assigned to a respective cell degassing opening of a battery cell, gas discharges from any cell of several battery cells can be detected with one sensor unit. Therefore, no additional sensor units need to be provided. For example, one such sensor unit can be provided per battery module.

The battery arrangement can, for example, provide or represent a battery, in particular a high-voltage battery. The battery, such as a high-voltage battery, can in turn have several battery modules. A battery module can contain several battery cells. These battery cells can be formed, for example, as lithium-ion cells. If several sensor units are provided, e.g. one per module, they can be connected to a common measuring device of the sensor device, in particular electrically conductively and/or communicatively connected.

In a further advantageous embodiment of the invention, the sensor unit comprises multiple connecting sections, wherein the respective detection sections are connected to one another via the connecting sections, wherein a respective connecting section is narrower with respect to the second direction than a respective detection section, in particular wherein a ladder structure is formed by the connecting sections and the detection sections, which comprises two opposite longitudinal struts and multiple rungs connecting the two longitudinal struts, wherein each rung comprises a detection section. The term ladder structure refers here to the geometric design of the sensor unit. This geometric shape can resemble a ladder. The individual sections of the sensor unit, namely the connecting sections and the detection sections, can therefore form two opposing longitudinal struts and several rungs connecting the two longitudinal struts, similar to the rungs of a ladder. This geometry is particularly advantageous when the battery cells are designed, for example, as prismatic battery cells or pouch cells and are arranged in relation to one another in the form of a cell stack. In this case, the respective cell degassing openings can be located along an imaginary line. The two longitudinal struts run accordingly in the stacking direction, on both sides of a respective releasable cell degassing opening, while a respective rung is arranged perpendicular to the stacking direction over the releasable cell degassing opening, but preferably does not contact it. Accordingly, it is advantageous if each rung has a detection section in which the sensor unit is widened. The detection sections can correspond in terms of their region to the region of the releasable cell degassing openings assigned to them. The remaining sections of the sensor unit, i.e. the connecting sections, can be made significantly less wide. The ladder structure described also provides a kind of frame for the sensor unit. This allows for particularly stable positioning. In particular, this makes it possible to manufacture the sensor unit as a separate component and, for example, to position it as a whole in an region between a battery module and a housing component of a battery housing, e.g. the housing base, which can be designed as a cooling base, or to arrange and fasten it on the underside, i.e. on a side of the housing component opposite the battery module or the cells, to such a housing component itself, wherein the housing component has a recess between an region of the sensor unit which comprises the detection sections and the cell degassing opening region in which the cell degassing openings of the cells of the module are arranged. Fixing it to the battery module itself is not absolutely necessary. In this case, a fixation can be understood to mean, in particular, a material-locking fixation, e.g. by means of gluing or welding, or also another fixation, e.g. by means of screws or rivets or similar. The sensor unit can, for example, be clamped between the battery module and the housing component and/or only be fixed to the housing component, e.g. by means of gluing.

It is also conceivable that the longitudinal struts and the rungs lie in a common plane or that the longitudinal struts and the rungs do not lie in a common plane. In this case, it can be provided, for example, that the longitudinal struts have a smaller distance to the battery cells than the rungs. In other words, the distance to the cells can be increased in the region of the rungs. The detection regions or detection sections of the sensor unit then have a correspondingly greater distance from the cell than the other regions. This allows a particularly large distance to be provided for the sensor unit, especially in the region of the cell degassing opening. This also makes it possible to arrange the sensor unit on the battery cells, namely via the longitudinal struts, e.g. just by placing it on the cells or the cell assembly, namely the cell stack, or by gluing or similar.

The connecting sections can be arranged at least partially in contact with the battery cells in a region of the cell housing in which the cell degassing opening is not arranged.

In a further advantageous embodiment of the invention, the carrier is formed as a carrier plate and/or carrier film. The sensor unit can in turn comprise multiple detection sections, wherein a respective detection section is assigned to exactly one cell degassing opening and is arranged opposite this, in particular with respect to the first direction. Such a detection section further defines a region of the carrier in which a conductor section of the electrical line is located. The sensor unit again preferably comprises multiple predetermined breaking points, with at least one of the predetermined breaking points being assigned to each detection section, with it being preferred in the present case that each such predetermined breaking point is designed as a predetermined breaking line that partially or completely runs around or frames the detection section. The predetermined breaking line can also be designed as a U-shaped line and run around the detection section except for one side contour of the detection section. When the gas stream hits the detector, the detection section can fold away like a flap. If the detection section is completely surrounded by the predetermined breaking lines, the detection section can be punched out when the gas flow hits it. The conductor can be arranged on the carrier plate or carrier film or embedded in it. The conductor can have a line arrangement that includes rung sections and longitudinal connectors. The rung sections run essentially parallel to each other. Each detection section comprises at least one rung section. The rung section can also form a conductor loop that runs from one side in the third direction into the detection section, turns around and runs back to the side against the third direction. The longitudinal connectors connect the individual rung sections with each other. The longitudinal connectors run essentially in the second direction. The line arrangement can, for example, also be provided as a conductor structure, in particular to provide a parallel connection of the detection sections, or run in a meandering or serpentine manner, in particular to provide a series connection of the detection sections.

In a further advantageous embodiment of the invention, the battery arrangement comprises a housing component, in particular a cooling plate, wherein the at least one battery cell comprises a first cell side with a first region, a second region and a third region, wherein the releasable cell degassing opening is arranged in the second region, which is arranged in a third direction between the first and third regions, wherein the first region and the third region are each arranged on the housing component via an interface material, and wherein with respect to the first direction below the second region there is a free region in which the sensor unit is arranged and which is located in the third direction between two sections of the housing component.

This embodiment is particularly advantageous, in particular when the housing component is a cooling base of a battery housing or a cooling cover of the battery housing or another cooling device which simultaneously represents a housing component. This advantageously makes it possible to thermally connect the battery cells to the housing component as well as possible via the interface material. The interface material can also be designed as a thermal interface material, e.g. as a gap filler or as a thermally conductive adhesive. If the housing component does not represent a cooling device, this design or the connection of the cells to the housing component via an interface material is also advantageous for other reasons, e.g. to increase the structural rigidity of the overall arrangement. In addition, an adhesive can be used as an interface material and, under certain circumstances, other options for attaching the battery module to the housing can be dispensed with.

On the one hand, the free region enables the gas flow to discharge more easily from an outgassing cell and, at the same time, offers space to accommodate the sensor unit for detecting this gas flow. The free region can be essentially rectangular or cuboid-shaped, wherein the free region and/or the distance of the sensor unit from the cell degassing opening has only a very small height in the first direction, which is for example only a few millimeters and in particular is less than one centimeter.

Furthermore, the invention also relates to a motor vehicle having a battery arrangement according to the invention or one of its embodiments.

Furthermore, the invention relates to a method for detecting a gas discharge from at least one battery cell which has a releasable cell degassing opening, wherein a sensor unit with an electrical line which is subjected to a test voltage is used to detect the gas discharge, wherein a gas discharging from the cell degassing opening strikes the sensor unit and damages the line, wherein the gas discharge is detected by detecting the damage to the electrical line. The electrical line is damaged by the outflow pressure of a gas discharging from the cell degassing opening during thermal runaway of the battery cell.

The advantages mentioned for the battery arrangement and its embodiments according to the invention thus apply similarly to the method according to the invention.

Depending on the detection of the gas discharge, a signal can be issued and/or an action can be triggered.

The invention also includes refinements of the method according to the invention, which have features as have already been described in conjunction with the refinements of the battery arrangement according to the invention. For this reason, the corresponding refinements of the method according to the invention are not described again here.

The motor vehicle according to the invention is preferably designed as an automobile, in particular as a passenger car or truck, or as a passenger bus or motorcycle.

The invention also comprises the combinations of the features of the described embodiments. The invention therefore also includes implementations which each have a combination of the features of several of the described embodiments, unless the embodiments have been described as mutually exclusive.

### BRIEF DESCRIPTION OF THE FIGURES

Exemplary embodiments of the invention are described hereinafter. In particular:

FIG. 1 shows a schematic representation in a cross-section of a battery arrangement according to one exemplary embodiment of the invention in a non-triggered state of the sensor unit;

FIG. 2 shows a schematic representation of the battery arrangement from FIG. 1 in a triggered state of the sensor unit according to an exemplary embodiment of the invention;

FIG. 3 shows a schematic representation of a battery arrangement with a sensor unit according to a further exemplary embodiment of the invention.

FIG. 4 shows a schematic representation of a battery arrangement with a sensor unit according to a further exemplary embodiment of the invention.

FIG. 5 shows a schematic illustration of a sensor unit for a battery arrangement in a top view according to one exemplary embodiment of the invention;

FIG. 6 shows a schematic illustration of a sensor unit for a battery arrangement according to another exemplary embodiment of the invention.

FIG. 7 shows a schematic representation of a part of a sensor unit for a battery arrangement according to a further exemplary embodiment of the invention;

FIG. 8 shows a schematic cross-sectional illustration of a battery arrangement according to another exemplary embodiment of the invention.

FIG. 9 shows a schematic representation in a plan view of a battery arrangement from FIG. 8 from below, according to a further exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

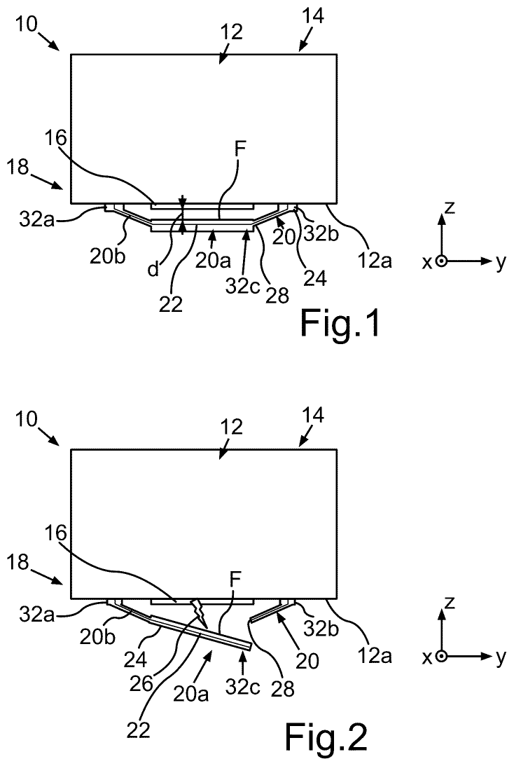

FIG. 1 shows a schematic cross-sectional illustration of the battery arrangement 10 according to an exemplary embodiment of the invention. The battery arrangement 10 comprises at least one battery cell 12, but preferably multiple such battery cells, which can form, for example, a battery module 14 with multiple battery cells 12 arranged next to one another in a stacking direction x. The battery arrangement 10 can, for example, provide a high-voltage battery or a part thereof. The battery cell 12 in the present example also has a releasable cell degassing opening 16 on its lower side 12a, which can be arranged for example as a cell membrane in the cell housing of the battery cell 12. The z-direction corresponds, for example, to a vehicle vertical direction of a motor vehicle based on a preferred installation position of the battery arrangement 10 in a motor vehicle. When a certain internal cell pressure is exceeded, the releasable cell degassing opening 16 opens the way for the gas to discharge. To detect this, the battery arrangement 10 comprises a sensor device 18, which in turn comprises a sensor unit 20. In addition to the sensor unit 20, the sensor device 18 can include, for example, a measuring device (not shown in detail) which is designed, for example, to apply a test voltage to an electrical line 22 in the form of an electrical conductor 22 encompassed by the sensor unit 20 and to detect and evaluate at least one electrical variable associated with the conductor 22, such as a resistance or a current intensity.

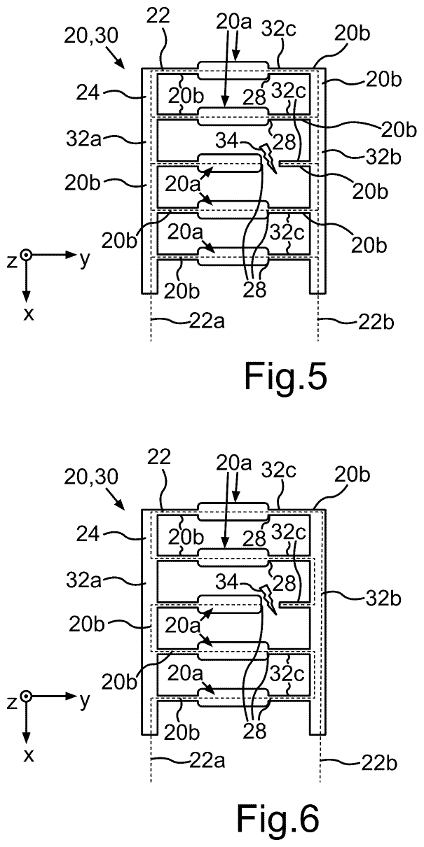

The sensor unit 20 thus comprises, as already mentioned, an electrical line 22 and in particular also a carrier 24 made of an electrically insulating material, such as plastic. The electrical line 22, which is also referred to below as conductor 22, can be arranged on the carrier 24 or can also be completely embedded in it, so that the electrical conductor 22 is completely electrically insulated from the outside by the carrier 24, for example except for two connection points 22a, 22b (cf. FIG. 5 and FIG. 6), via which they can be connected to the unit 20 to the measuring device described and via which the conductor 22 can be subjected to a test voltage.

For simplified description, the sensor unit 20 can be divided into several sections. The sensor unit 20 preferably has an associated detection section 20a for each releasable cell degassing opening 16, which can also be referred to as detection region 20a. In this detection section 20a, the carrier 24 can be widened relative to the electrical conductor 22, in particular in this example in and against the illustrated x-direction. The surface F provided by the carrier 24 in the detection section 20a, which is oriented perpendicular to the z-direction shown, can correspond in terms of its geometric design to the dimensions of the releasable cell degassing opening 16. The carrier 24 in the detection region 20a provides a particularly large flow resistance with respect to the gas flow 26 exiting the cell (cf. FIG. 2), which is illustrated in FIG. 2 by way of example by an arrow 26. This in turn has the great advantage that the temperatures of such an discharging gas 26 cannot be used to trigger the sensor unit 20, or not exclusively, but additionally or alternatively also the gas pressure which occurs and acts on the sensor unit 20, especially in the detection region 20a.

If the battery arrangement 10 comprises multiple battery cells 12, the sensor unit 20 can also comprise a corresponding number of detection sections 20a, as can be seen, for example, in FIG. 5 and FIG. 6. The remaining sections of the sensor unit 20 are referred to as connecting sections 20b, which may also be called connecting regions 20b. Not all connecting sections 20b must necessarily comprise an electrical conductor 22, but can, for example, also be formed exclusively by the electrically insulating material of the carrier 24. This depends in particular on the routing of the electrical line 22 and the electrical circuits formed by it and their design, as will be explained in more detail later.

Furthermore, it is advantageous if the carrier 24 or generally the sensor unit 20 is narrower in the region of the connecting sections 20b with respect to the x-direction than in the detection section 20a. This makes it easier to damage the sensor unit 20 in the event of gas discharge 26. In addition, it is advantageous if the sensor unit 20 has at least one predetermined breaking point 28, which in this example is arranged in one of the connecting sections 20b and adjacent to or in a predetermined proximity to the detection section 20a.

In addition, the sensor unit can be geometrically designed as a ladder structure 30 (see FIG. 5 and FIG. 6). Accordingly, the sensor unit 20 can be divided into two opposing longitudinal struts 32a, 32b and rungs 32c connecting these longitudinal struts 32a, 32b. Each detection section 20a is part of such a rung 32c. In particular, the connecting sections 20b or the parts of the connecting sections 20b, which are simultaneously also part of such a rung 32c, can be made narrower at least in the x-direction, in particular in the region of the detection regions 20a as well as in the region of the longitudinal struts 32a, 32b. In particular, the longitudinal struts 32a, 32b can have a greater width in the y-direction than the connecting sections 20b in the x-direction, which are simultaneously part of a rung 32c. This design forces a simple break or a simple severing of the sensor unit 20 in the region of the rungs 32c, especially in a connecting region 20b different from the detection region 20a.

FIG. 2 shows a schematic representation of the battery arrangement 10 from FIG. 1 in a now triggered state of the sensor unit 20. In this case, gas 26 emerges, for example, from the releasable cell degassing opening 16 of the battery cell 12. As a result of the gas pressure that arises when the gas 26 hits the detection section 20a of the sensor unit 20, the sensor unit 20 breaks in the region of the predetermined breaking point 28, which is assigned to the relevant detection region 20a. As a result, the sensor unit 20 and in particular the electrical conductor 22 are now interrupted in the region of this predetermined breaking point 28. This can now be advantageously used by evaluating the above-described at least one electrical variable of the conductor 22 to detect the gas discharge 26, as will be explained in more detail later.

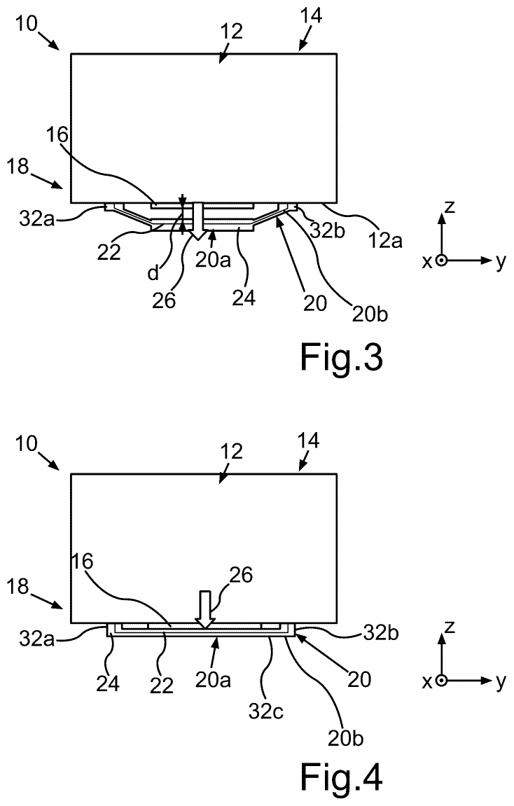

In addition, it is also possible to use not only the gas pressure resulting from the impact of the gas 26 on the detection section 20a to trigger the sensor unit 20, but also the temperature of the hot discharging gas flow 26, as is illustrated by way of example in FIG. 3.

FIG. 3 shows a battery arrangement 10 according to a further exemplary embodiment of the invention. It can be designed as described above, except for the differences described below. This example again illustrates how gas 26 exits the cell 12 and hits the detection region 20a, which is arranged directly below the releasable cell degassing opening 16 with respect to the illustrated z-direction. In this case, the discharge and the gas flow 26 do not lead to a breakage of the sensor unit 20 in the region of the predetermined breaking point 28, but to a melting of the sensor unit 20 in the region of the detection section 20a. Accordingly, in this example, the sensor unit 20 does not necessarily have to be designed with the predetermined breaking points 28 described for FIG. 1 and FIG. 2, but this is nevertheless possible. If, for example, the force is not sufficient to sever the conductor 22 due to insufficient gas pressure, the heat effect of the discharging gas 26 can also be used, if present, to cause damage to the conductor 22, which in this example represents a melting of the sensor unit 20 including the conductor 22 in the region of the detection region 20a. Also interrupted by such a melting with the conductor 22, which in turn can be measured, whereby the gas discharge 26 can be detected.

This can further increase safety, since the described battery arrangement 10 and in particular the described sensor device 18 make it possible to use both the gas pressure of the gas 26 discharging from its cell 12 as well as the temperature of the gas 26 to trigger the sensor unit 20. If the degassing of the cell 12 takes place, for example, in the form of a cold degassing, this can be detected, for example, by pressure-related damage to the sensor unit 20. If the discharging gas pressure of a hot outgassing cell 12 is too low, the outgassing can be detected by melting of the sensor unit 20. This makes it possible to reliably and, above all, early detect a gas discharge in many different situations.

In the examples shown in FIG. 1 to FIG. 3, the sensor unit 20 also has a distance from the cell degassing opening 16, at least with respect to the z-direction shown. This distance is designated by d in FIG. 1 and FIG. 3 and is preferably in the millimeter range, particularly preferably in the single-digit millimeter range. The sensor unit 20 can therefore advantageously be designed such that no physical contact with the cell degassing opening 16 is necessary. The longitudinal struts 32a and 32b can provide support relative to the battery module 14. In other words, the sensor unit 20, as shown, can be arranged on the battery module 14 and on the cells 12 which are comprised by this module 14, but in the region of the detection sections 20a it can have a certain distance d from the respective cell degassing openings 16 located above them. This additionally prevents the gas discharge 26 from being impaired or obstructed, especially if the region F of the detection sections 20a is designed to be wide.

FIG. 4 shows a schematic illustration of a battery arrangement 10 according to a further exemplary embodiment of the invention. This also has a sensor device 18 with a sensor unit 20. The battery arrangement 10 can also be designed as described above, only with the differences described below. In this example, the sensor unit 20 is arranged directly at the cell degassing opening 16. Nevertheless, by providing the electrically insulating carrier 24 in which the conductor 22 is embedded, there is still a certain distance, albeit small, between the conductor 22 and the cell degassing opening 16. There is therefore no direct contact between the conductor 22 and the cell degassing opening 16. This allows for a slightly flatter design in the z-direction.

FIG. 5 shows a schematic illustration of a sensor unit 20, which has the form of a ladder structure 30, for a battery arrangement 10 according to an exemplary embodiment of the invention. The sensor unit 20 can be designed in particular as described in relation to FIG. 1 and FIG. 2. In this example, the electrical conductor 22 is designed in the form of a parallel circuit, e.g. the individual line resistances of the rungs 32c. In other words, the electrical conductor 22 is provided in the form of a conductor arrangement or conductor track arrangement 22 which forms such a parallel circuit. For example, the individual charge resistances associated with the respective rungs 32c may all be the same. If damage 34 occurs to the sensor unit 20 in the region of one of the rungs 32c, e.g. a break at the predetermined breaking point 28, the overall resistance of the entire arrangement also changes. In particular, the following applies to the total resistance R_{G}:

$${R}_{G} = R / N .$$

R represents an individual electrical resistance associated with a respective rung 32c, e.g. a line resistance of this rung 32c. N represents the number of undamaged, i.e. non-severed, rungs 32c. It is assumed that the resistances of the respective rungs 32c are all the same. If this is not the case, the calculation is somewhat more complex, but it is nevertheless possible to detect a rung breakage or a severance in the same way. If a cut occurs in the region of one of the rungs 32c of the conductor 22, the number N of non-cut rungs 32c changes accordingly, e.g. by 1. The total resistance R_{G}changes accordingly. In the case of the five rungs shown and assuming a rung resistance R of one milliohm (mΩ), the total resistance R_{G} before the cell opening is 0.2 milliohms and after the cell opening is 0.25 milliohms. As a result of this change in the total resistance R_{G} the severance of the line 22 in the region of one of the rungs 32c can be detected and the gas discharge 26 can thus be detected. This detection method also makes it possible to determine the number of severed rungs based on the total resistance. Depending on the value of the total resistance, it can also be detected if more than one cell 12 opens. In particular, the number of cells 12 of the battery arrangement 10 affected by such a gas discharge 26 can be determined, e.g. by means of the measuring device described above.

A somewhat simpler and preferred embodiment of the sensor unit 20 in the form of a ladder structure 30 is shown schematically in FIG. 6. This can in particular be designed as described for FIG. 5, except for the differences described below: In this example, a conductor track arrangement is provided by the conductor 22, which represents a series connection, e.g. of the individual line resistances of the rungs 32c. If the conductor 22 breaks, for example, in the region of one of the rungs 32c, e.g. in the region of the predetermined breaking point 28 described above, this leads to an interruption of the current flow. This can be detected by the measuring device. This design is particularly simple. In addition, with this variant the measurement accuracy is not dependent on the number of rungs 32c. In other words, the number of possible rungs 32c is not limited by a given measurement accuracy for detecting the electrical variable of the conductor 22.

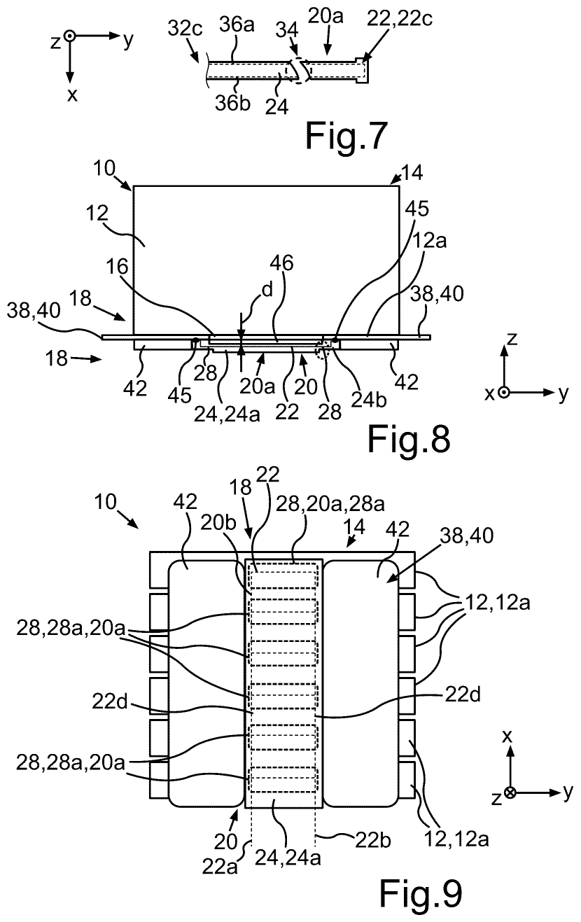

FIG. 7 shows a further design possibility of a single rung 32c for a sensor unit 20 according to a further embodiment of the invention. The conductor 22 can pass through a respective rung 32c or any other section 20a, 20b of the sensor unit 20 not only once, but also multiple times, e.g. twice, as shown here in the form of a conductor loop 22c formed by the conductor 22. This also makes it easy to provide a series connection of the individual line resistances assigned to the respective rungs 32c, as explained in FIG. 6. In this case, damage 34 of the conductor 22 in the region of the rung 32c is also illustrated, which has led to a double severing of the conductor 22. However, a simple severing would also be detectable, as it would result in an interruption of conductor 22. This means that a rung 32c does not have to be completely severed even in a series connection so that the gas discharge 26 can be detected. It is sufficient, for example, if the rung 32c is damaged in such a way that only one of the two 36a, 36b of the conductor 22 is damaged or severed. The other of the two sections 36a, 36b can remain intact.

FIG. 8 shows a schematic cross-sectional illustration of a battery arrangement 10 according to another exemplary embodiment of the invention. This can also be designed as described above, except for the differences described below: On the one hand, additional components of the battery arrangement 10 are now shown here, which can also be provided in the previously described embodiments. This is in particular a housing component 38 which is arranged below the battery module 14 or the cell 12 with respect to the z-direction and which in the present example is designed as a cooling plate 40 with two cooling channels 42. The cooling channels 42 are arranged at a position which, with respect to the cell direction, is not directly opposite the releasable cell degassing opening 16 of the cells 12 of the battery module 14. Rather, these cooling channels 42 extend to the left and right of the cell degassing region, relative to the y-direction shown.

In this example, the sensor unit 20 is arranged on the cooling plate 40 with the cooling channels 42. The cooling plate 40 can in turn be arranged on the module 14 via a thermally conductive adhesive or a gap filler. The sensor unit 20 can be arranged in a sealed manner on the cooling plate 40 by means of seals 45, e.g. glued thereto. The adhesive used for bonding can optionally also simultaneously take over the function of the seals 45 or it can represent the seals 45, or the seals 45 can be provided additionally. The same applies when the carrier 24 is designed as at least one carrier film, as described below.

The cooling plate 40 has a recess in which or below which the sensor unit is arranged with respect to the z-direction, in particular on the cooling plate 40 itself. The sensor unit 20 in turn comprises a conductor structure, wherein this conductor structure in this example is implemented only by the electrical conductor 22, which is comprised by the sensor unit 20, but not by the carrier 24, which in this example is designed as a continuous carrier plate 24a. Alternatively, the carrier 24 can also be designed analogously as at least one carrier film. The electrical conductor 22 can be arranged on the carrier film or can be laminated between two carrier films. The at least one carrier film can also be flat. Such a carrier film can be very thin, e.g. with a maximum thickness of a few millimeters, or a maximum of one millimeter or less than one millimeter. The at least one carrier film can be attached to the conductor 22 arranged thereon or therein by gluing in the battery arrangement 10, e.g. by gluing it to the underside 12a of the at least one battery cell 12 or by gluing it to the cooling plate 40 itself on a side of the cooling plate 40 opposite the at least one battery cell 12, e.g. in the region in which the seals 45 are shown in FIG. 8.

FIG. 9 shows again a schematic representation of the battery arrangement 10 from FIG. 8 in a plan view from below or a similar battery arrangement 10 according to a further exemplary embodiment of the invention, according to which the carrier 24 is designed as a carrier film. Although the electrical conductors 22 are also shown here, they can nevertheless be completely embedded in the electrically insulating material of the carrier 24. In this example, the sensor unit 20 comprises multiple predetermined breaking points 28. In this example, these are designed as predetermined breaking line 28a and define, for example, a respective previously explained detection region 20a of the sensor unit 20 or encircle it, wherein again one such detection region 20a is provided per cell degassing opening 16. The predetermined breaking point 28 or predetermined breaking line can be designed as a material weakening, notch, perforation, puncturing or similar. Preferably, the predetermined breaking point 28 or predetermined breaking line 28a is designed such that there is no complete penetration of the sensor unit with respect to the z-direction. As a result, the cell degassing opening 16 in particular is significantly better protected against environmental influences, and penetration of dirt or liquid or the like into the remaining gap 46 can be avoided.

In this example too, a respective detection section 20a again has a certain distance d from the cell degassing opening 16. If the carrier 24 is designed as a plastic plate 24a, the plastic plate 24a can in turn provide a type of frame 24b which runs in the region in which the longitudinal sections 22d of the conductor track arrangement 22 running in the x-direction are also provided. The carrier 24 can also be designed as a carrier film which is glued to the cooling plate 40, e.g. along an outer contour of the carrier film, which has the shape of a surrounding frame.

The detection of damage to the sensor unit 20 can, for example, be carried out in the present example as described in FIG. 5. Furthermore, it is conceivable to provide a series circuit, as in FIG. 6, only in a closed plastic plate 24a and to implement it analogously by means of an alternative routing and design of the conductor 22.

Overall, the examples show how a sensor for the degassing of battery cells or a sensor for the opening of cell modules can be provided. The idea includes possibilities to detect this case with a resistance measuring loop. For this purpose, a (plastic) frame or a (plastic) plate or a (plastic) film enclosing an electrical conductor can be applied to the cell side or module side with the degassing openings. The conductor crosses the degassing region of the cell and the plastic frame simultaneously forms a flat region here. When the cell degasses, the pressure hits the cell with the conductor and thus leads to a tearing of the thin connections to the frame, which can also be designed with a predetermined breaking point or are designed as predetermined breaking points due to their thin design. The conductor can also be severed or burned through by the hot exhaust gas stream. Alternatively, the conductors can be arranged in a plastic plate with predetermined breaking points, which in turn is attached to the module or cells and seals the degassing openings to the outside. The invention has the advantage that the frame or plate can be easily applied and scaled and the interruption of the line can take place independently of temperatures. In addition, some cell manufacturers do not allow components to be placed directly on the degassing openings.

1. A battery arrangement with a sensor device for detecting a gas discharge from at least one battery cell of the battery arrangement, comprising:
at least one battery cell which has a releasable cell degassing opening,
wherein the sensor device, for detecting the gas discharge, comprises a sensor unit with an electrical line to which a test voltage can be applied,
wherein the sensor unit is arranged such that a gas emerging from the cell degassing opening impinges on the sensor unit, and
wherein the electrical line can be damaged by a gas flowing out of the cell degassing opening,
wherein the sensor unit is designed in such a way that the electrical line can be damaged by the flow pressure of a gas discharging from the cell degassing opening in the event of thermal runaway of the battery cell.

2. The battery arrangement according to claim 1, wherein the electrical line is arranged at a distance from the releasable cell degassing opening and/or the sensor unit has a carrier made of an electrically non-conductive material on which the electrical line is arranged and/or in which the electrical line is embedded, in particular wherein the carrier provides a frame and/or is designed as a carrier plate and/or as a carrier film.

3. The battery arrangement according to claim 1, wherein there is a free space, in particular a gap, between the cell degassing opening and the sensor unit in a first direction.

4. The battery arrangement according to claim 1, wherein the sensor device is designed to detect damage to the line to which the test voltage is applied as a function of a measured electrical variable associated with the line and to detect the gas discharge as a function of the detected damage to the line.

5. The battery arrangement according to claim 1, wherein the sensor unit has a predetermined breaking point, wherein the line can be damaged by damage or breakage of the sensor unit at the predetermined breaking point, in particular wherein the predetermined breaking point is formed in the carrier.

6. The battery arrangement according to claim 1, wherein the sensor unit has a detection section which is directly opposite the cell degassing opening of the battery cell with respect to a gas discharge direction, wherein the carrier has, at least in the detection section, a carrier surface which is wider with respect to a second direction than a conductor surface of the electrical line.

7. The battery arrangement according to claim 1, wherein
the battery arrangement has multiple battery cells with respective releasable cell degassing openings,
wherein the sensor unit comprises multiple detection sections,
wherein a respective detection section is assigned to exactly one cell degassing opening,
wherein the sensor unit has a multiple predetermined breaking points,
wherein each detection section is assigned at least one of the predetermined breaking points, which is arranged in particular in an edge region of the detection section and/or adjacent to the detection section.

8. The battery arrangement according to claim 1, wherein the sensor unit comprises multiple connecting sections, wherein the respective detection sections are connected to one another via the connecting sections, wherein a respective connecting section is narrower with respect to the second direction than a respective detection section, in particular wherein a ladder structure is formed by the connecting sections and the detection sections, which comprises two opposite longitudinal struts and multiple rungs connecting the two longitudinal struts, wherein each rung comprises a detection section.

9. The battery arrangement according to claim 1, further comprising a housing component, in particular a cooling plate, wherein the at least one battery cell comprises a first cell side with a first region, a second region and a third region, wherein the releasable cell degassing opening is arranged in the second region, which is arranged in a third direction between the first and third regions, wherein the first region and the third region are each arranged on the housing component via an interface material, wherein, with respect to the first direction, there is a free region below the second region in which the sensor unit is arranged, and which is located in the third direction between two sections of the housing component.

10. A method for detecting a gas discharge from at least one battery cell having a releasable cell degassing opening,
wherein a sensor unit with an electrical line is used to detect the gas discharge, which line is subjected to a test voltage,
wherein a gas discharging from the cell degassing opening impinges on the sensor unit and damages the line,
wherein the gas discharge is detected by detecting the damage to the electrical line,
wherein the electrical line is damaged by an outflow pressure of a gas discharging from the cell degassing opening.

11. The battery arrangement according to claim 2, wherein the sensor device is designed to detect damage to the line to which the test voltage is applied as a function of a measured electrical variable associated with the line and to detect the gas discharge as a function of the detected damage to the line.

12. The battery arrangement according to claim 3, wherein the sensor device is designed to detect damage to the line to which the test voltage is applied as a function of a measured electrical variable associated with the line and to detect the gas discharge as a function of the detected damage to the line.

13. The battery arrangement according to claim 2, wherein the sensor unit has a predetermined breaking point, wherein the line can be damaged by damage or breakage of the sensor unit at the predetermined breaking point, in particular wherein the predetermined breaking point is formed in the carrier (24).

14. The battery arrangement according to claim 3, wherein the sensor unit has a predetermined breaking point, wherein the line can be damaged by damage or breakage of the sensor unit at the predetermined breaking point, in particular wherein the predetermined breaking point is formed in the carrier.

15. The battery arrangement according to claim 4, wherein the sensor unit has a predetermined breaking point, wherein the line can be damaged by damage or breakage of the sensor unit at the predetermined breaking point, in particular wherein the predetermined breaking point is formed in the carrier.

16. The battery arrangement according to claim 2, wherein the sensor unit has a detection section which is directly opposite the cell degassing opening of the battery cell with respect to a gas discharge direction, wherein the carrier has, at least in the detection section, a carrier surface which is wider with respect to a second direction than a conductor surface of the electrical line.

17. The battery arrangement according to claim 3, wherein the sensor unit has a detection section which is directly opposite the cell degassing opening of the battery cell with respect to a gas discharge direction, wherein the carrier has, at least in the detection section, a carrier surface which is wider with respect to a second direction than a conductor surface of the electrical line.

18. The battery arrangement according to claim 4, wherein the sensor unit has a detection section which is directly opposite the cell degassing opening of the battery cell with respect to a gas discharge direction, wherein the carrier has, at least in the detection section, a carrier surface which is wider with respect to a second direction than a conductor surface of the electrical line.

19. The battery arrangement according to claim 5, wherein the sensor unit has a detection section which is directly opposite the cell degassing opening of the battery cell with respect to a gas discharge direction, wherein the carrier has, at least in the detection section, a carrier surface which is wider with respect to a second direction than a conductor surface of the electrical line.

20. The battery arrangement according to claim 2, wherein
the battery arrangement has multiple battery cells with respective releasable cell degassing openings,
wherein the sensor unit comprises multiple detection sections,
wherein a respective detection section is assigned to exactly one cell degassing opening,
wherein the sensor unit has a multiple predetermined breaking points,
wherein each detection section is assigned at least one of the predetermined breaking points, which is arranged in particular in an edge region of the detection section and/or adjacent to the detection section.
